(19) United States
(12) Patent Application Publication
(10) Pub. No.: US 2016/0223449 A1
(43) Pub. Date: Aug. 4, 2016

(54) ROTARY RHEOMETER

(71) Applicant: ANTON PAAR GMBH, Graz (AT)

(72) Inventors: RONALD HENZINGER, GRAZ (AT); JOSEF GAUTSCH, GRAZ (AT)

(21) Appl. No.: 15/021,358

(22) PCT Filed: Aug. 25, 2014
(86) PCT No.: PCT/AT2014/050181

§ 371 Date: Mar. 11, 2016

(30) Foreign Application Priority Data
Sep. 11, 2013 (AT) A 50570/2013

(51) Int. Cl. G01N 11/14

(52) U.S. Cl. CPC G01N 11/14

(57) ABSTRACT

A rotary rheometer has a stator arranged in a rotationally invariant fashion, and a rotor that can be rotated about the axis of the stator by an eddy current drive. Wherein the test medium to be examined can be introduced into at least one measuring gap formed between surfaces of the rotor and the stator located opposite of one another. Accordingly, the measuring gap filled with the test medium to be examined functions as and/or is configured as a hydrodynamic bearing between the rotor and the stator. The distance and mutual position of the mutually facing surfaces of the rotor and the stator defining the measuring gap are predetermined and set, and are maintained during the measuring process, exclusively by the hydrodynamic bearing action generated by the rotation of the rotor relative to the stator.

The invention relates to a rotary rheometer for determining the viscous and/or rheological properties of fluid media according to the precharacterizing clause of claim 1.

With rotary rheometers, it is possible to determine the viscous and rheological properties and parameters of fluids, in particular the dynamic viscosity of fluids.

In rheometers according to the invention, a measurement body configured as a rotor runs around or in or opposite a stator or stator part(s). The measurement gap lies between the rotor and the stator. Eddy current driving of the rotor is carried out. Furthermore, a measurement of the rotational speed specified by the drive and the actual rotational speed of the rotor during the measurement is carried out, and the rotational speed difference is used as a measure of the viscous/rheological properties of the test medium. According to the invention, hydrodynamic bearing of the rotor relative to the stator is provided.

GB 1197476 (A) discloses a rheometer in which the cylindrical gap between the rotor and the stator of a three-phase induction motor provides a passage for the test fluid to be measured; the rotor is in this case supported by a spindle and bearings.

Measurement systems with measurement bodies having cylindrical surfaces generally comprise a measurement body (inner cylinder) and a measurement cup (outer cylinder). In the measurement position, the two cylinders are arranged concentrically, i.e. the axes of the cylinders coincide. In the case of such cylinder rotary rheometers, the test medium to be measured lies in the annular gap between the inner and outer cylinders. When the inner cylinder rotates, this is referred to as a Searle system, and in the converse case it is a so-called Couette system.

There are no fundamental differences in the structure of rotary rheometers and rotary viscometers. In each case, a rotor is moved relative to a stator and the lag angle or rotational speed differences are determined. A different structure, or different designs and measurement bodies, are only used for different tasks and as a function of the fluids to be tested.

Often, rotary rheometers are used for measuring rheological properties of non-Newtonian fluids, complex rheometers in this case measuring above all the shear rate-dependent behavior of the fluids.

Searle viscometers comprise a stationary cup in which a coaxial cylinder body is rotated in the measurement liquid by means of a motor. In this case, generally either the velocity gradient is measured while specifying a defined shear stress or the shear stress is measured while specifying a defined velocity gradient (constant rotational speed).

Very generally, in rotary viscometers the measurement body should be mounted as far as possible without friction in order to jointly measure if possible no bearing friction during the measurement of the rotational speeds, or of the torques occurring. In contrast to the conventional perpendicular arrangement, the rotational symmetry axis may in this case also extend in the horizontal position or in an inclined fashion. The rotor, supported at most without contact in the outer cylinder by magnets, may be kept in its ideal position by a complex control and measurement system and contactlessly driven inductively. The structure of such a viscometer and the rotor bearing are, however, extremely complex. Above all, the rotor is influenced by the magnets and bearing friction or bearing forces cannot fully be excluded.

The test medium to be studied lies in the measurement gap between the rotor and the stator. The driving of the rotor functioning as a measurement body is carried out in the rheometer according to the invention by an eddy current drive. To this end, for example, permanent magnets are rotated about the stator axis or rotor axis or a revolving (rotating) magnetic field is created around the stator axis or rotor axis, specifically by at least two, preferably more, induction coils which induce voltages in the conductive measurement body, or in the rotor, and therefore lead to eddy currents. In this way, a Lorentz force which rotates the measurement body is created perpendicularly to the magnetic field lines.

An alternative variant of an eddy current drive is achieved by a magnetic rotor, or a rotor equipped with permanent magnets. A concentrically arranged conductive eddy current body rotates externally around the measurement gap, or around the rotor. Currents are induced in this eddy current body because of its rotation around the permanent magnets, and these currents in turn induce voltages, or eddy currents, inside the rotor, which for their part generate their own magnetic fields opposing the prevailing magnetic field according to Lenz's law, which finally drive the rotor.

Generally considering the flow conditions of a fluid in a shear gap between two cylinders, a velocity gradient is formed between the inner and outer cylinder surfaces, i.e. shearing with a predetermined velocity gradient takes place. The torque M which is transmitted to the inner or outer cylinder by the gradient is directly proportional to the dynamic viscosity. Considering two volume elements, they always experience the same angular acceleration, but the outer volume element experiences greater centrifugal forces, so that Couette arrangements are actually more stable than Searle arrangements, the outer volume elements experiencing the higher velocities in the case of Couette arrangements. In the case of a Searle arrangement, the inner cylinder is rotated and there is a velocity profile in which the inner liquid layers rotate with higher velocity while the outer layers rotate more slowly, which can lead to vortex formation.

Because of the movement of the inner cylinder, and therefore the maximum velocity at the inner cylinder, a Searle system is always the more unstable variant since the vortex formation takes place primarily because of the centrifugal forces acting. This so-called Taylor-Couette vortex formation is known. The occurrence of these vortices restricts the use of Searle systems. In order to achieve a laminar flow in the measurement gap, the in principle very wide measurement range is restricted, particularly for fluids with low viscosity.

In general, the advantages of a Searle arrangement are the high possible shear rates, the homogeneous shear rate distribution and the low sensitivity to sedimentation phenomena. Disadvantages are the edge or end effects with necessary correction, the occurrence of vortices and the need for exact calibration, or measurement gap control.

The bearing of a rotor exclusively with magnets, or by means of a magnetic field, does not work in the case of contactless coupling between the rotor and the drive since in this case, because of the magnetic forces which decrease with the square of the distance, an imbalance is always created in the rotor and this arrangement can only work with very high speeds of the rotor (for example 10 000 rpm)—otherwise the rotor impacts or rubs against the stator. A strong magnetic field furthermore leads to almost rigid coupling between the rotor and the driving magnetic field, and causes the same rotational speed of the magnetic field and the rotor, at most with a small rotation angle between the rotor and the stator, set up during the test and influenced by the magnetic field, which cannot be detected or can be detected only with great difficulty.

The object of the invention is to avoid the disadvantages of the known arrangements, or rheometers, and to provide a rotary rheometer which is constructed simply, delivers precise measurement values and can be operated without bearing forces, in particular mechanical and magnetic bearing forces.

According to the invention, these objects are achieved in the case of a rotary rheometer of the type mentioned in the introduction by the features mentioned in the characterizing part of patent claim 1. Provision is thus made for the measurement gap filled with the test medium to be studied to function, or be configured, as a hydrodynamic bearing between the rotor and the stator, and exclusively by the hydrodynamic bearing effect achieved by the rotation of the rotor relative to the stator, for the distance and the mutual position of the surfaces, facing toward one another and delimiting the measurement gap, of the rotor and the stator to be specified and adjusted and to be maintained during the measurement process.

It is merely necessary to measure the rotational speed of the rotor and to know the drive rotational speed acting on the rotor, or its setpoint rotational speed, in order, unaffected by bearing influences, to obtain values that allow direct inference of the rheological parameters. The only effect on the rotor rotational speed takes place because of the test medium, which slows the rotation of the rotor owing to its inherent properties.

It is straightforward for the person skilled in the art to set up the gap geometry necessary for a hydrodynamic bearing effect for different test media. This may, in particular, be done by approximately determining beforehand the parameters to be determined, then adjusting the measurement gap, or adapting it to these parameters, and then determining these parameters with maximum accuracy with a rotary rheometer according to the invention. The rotational speed with which the rotor rotates may also be matched to the parameters of different test media, and likewise the temperature and pressure of the test medium may be taken into account in order to achieve unproblematic hydrodynamic bearing during the measurement process. It is therefore advantageous for the geometry, preferably the distance and the distance profile, of the mutually opposing surface sections of the measurement gap, in particular the radial distance of the mutually opposing surfaces, enclosing the rotation axis, of the rotor and the stator to be selected in order to form the hydrodynamic bearing as a function of the rotational speeds applied by the drive unit, a viscosity value estimated beforehand and/or rheological parameters of the test medium which are estimated beforehand. Unproblematic bearing is assisted when a flow which is sufficiently laminar and vortex-free for the formation of a hydrodynamic bearing is formed in the measurement gap during rotation of the rotor.

For stable formation of a hydrodynamic bearing in a rotary rheometer for the measurement operation, it is advantageous that the end regions of the measurement gap communicate freely, in particular without a cross-sectional narrowing of the end region of the measurement gap, with the outer regions following on from these end regions, or the test medium lying in these regions, or the end regions merge directly into these outer regions.

For obtaining precise measurement values, provision is advantageously made that the rotor, apart from its hydrodynamic bearing in the region of the measurement gap, is supported without contact and without a bearing, and in particular also without magnetic bearings, on or opposite the stator in the radial direction relative to its rotation axis.

A preferred embodiment of the invention is obtained when, in order to form the eddy current drive, which sets the rotor in rotation, the rotor preferably entirely is formed from nonmagnetic, nonmagnetizable, electrically conductive material, and permanent magnets which can be rotated about the stator axis are mounted around the rotor or at least partially inside the rotor or electromagnetic coils, with which a magnetic field that can be rotated about the stator axis can be generated, are mounted around the rotor or at least partially inside the rotor. As an alternative thereto, provision may be made that, in order to form the eddy current drive, which sets the rotor in rotation, the rotor preferably entirely is formed from nonmagnetic, nonmagnetizable, electrically conductive material, and that permanent magnets or coils are mounted at least partially inside the stator, the permanent magnets being rotatable about the stator axis and a magnetic field that rotates about the stator axis being generatable with the coils.

According to another embodiment of the invention, in order to form the eddy current drive which sets the rotor in rotation, permanent magnets are arranged positionally fixed inside the rotor, or are connected to the rotor, and an eddy current body formed preferably entirely of nonmagnetic, nonmagnetizable, electrically conductive material, preferably a cage, a pot or a conductor loop, is provided, which can be rotated around the rotor.

According to an embodiment of the invention which can be used well in practice, and delivers precise measurement values, the rotor is arranged in the interior of a stator having a rotationally symmetrical inner wall and the shape of a rotationally symmetrical container or cup, in order to form the eddy current drive which sets the rotor in rotation, permanent magnets being arranged positionally fixed inside the rotor, or being connected to the rotor, and the material of the container or cup, preferably entirely, being nonmagnetic, nonmagnetizable, electrically nonconductive material and an eddy current body formed of nonmagnetic, nonmagnetizable, electrically conductive material, preferably a pot, a cage or a conductor loop, being provided, which can be rotated around the stator.

It may be advantageous if a rotor having a cylindrical circumferential surface and at most end surfaces inclined thereto is provided, which is fully enclosed on all sides by an interior, having a cylindrical inner wall surface and at most end surfaces inclined thereto, of the stator and inside this interior by the test medium, an eddy current body, which preferably has the shape of a pot, a cage or a conductor loop and is formed from nonmagnetic or nonmagnetizable, electrically conductive material, being mounted rotatably around the stator, permanent magnets being mounted in the rotor or connected thereto. For practical purposes, it is expedient for the stator in this case to have a closable introduction opening for the test medium.

For the bearing of the rotor, it is particularly advantageous during measurement that in order to stabilize the position of the rotor with respect to the stator in the longitudinal direction of the stator axis, mutually opposing interacting permanent magnets and soft iron parts, which contactlessly stabilize the longitudinal position of the rotor relative to the stator axis (B), are arranged on the rotor and on the stator.

A precise eddy current drive which can be regulated well is obtained when the rotor and/or the stator and/or the eddy current body rotated around the rotor have a high electrical conductivity and are optionally made of Cu, Pt, Ag or Au.

The possibility for use of the rheometer according to the invention is increased when heating and/or cooling units for the test medium are arranged in the stator.

The geometry of the measurement gap may be selected in different ways. It is advantageous that, in a section extending through the rotation axis of the rotor, or through the stator axis, the measurement gap, or the surfaces of the rotor and the stator delimiting the measurement gap, have at least one straight, kinked, bent and/or curved section which extends in an inclined fashion with respect to the rotation axis, or with respect to the stator axis, or makes therewith an acute angle whose vertex is directed into the interior of the measurement gap and/or that mutually opposing surfaces of the measurement gap are respectively configured centrally symmetrically with respect to the rotation axis, and/or that the surfaces delimiting the measurement gap respectively extend symmetrically with respect to a mid-plane, extending perpendicularly to the rotation axis, of the measurement gap. For measurement operation, it is furthermore advantageous that the rotor is configured cylindrically, annularly, in the shape of a pot, in the shape of a cone or frustoconically or, in section in a plane extending through the rotation axis, triangularly, trapezoidally or as a segment of a conic section or of an ovoid.

In general, it is advantageous for the measurement gap to be selected to be as narrow as possible.

In order to achieve defined bearing of the rotor without friction radially and axially, but without losing the advantages of hydrodynamic bearing, provision may be made that a surface of the stator or of one stator part or of a further stator part respectively lies opposite the rotor on at least one of its surfaces, i.e. on its inner surface and/or outer surface, and/or on at least one end surface, and during its rotation, the rotor is supported without contact in the radial and optionally also in the axial direction with respect to the stator axis by the hydrodynamic bearing effect of the test fluid prevailing in the respective measurement gap between the respective surfaces.

For optimal bearing, provision may be made that the stator is configured in the shape of a closed pot or cylinder, and in that a rotor having the shape of an open pot is fitted with its interior on this stator while forming the measurement gap, at least one stator part and/or a further stator part optionally in addition being placed on the side of the rotor facing away from the stator at a distance from the rotor, in particular opposite its end wall and/or circumferential wall, and this distance between the rotor and the respective stator part or further stator part optionally being configured as a measurement gap causing hydrodynamic bearing.

A rotary rheometer which is constructed straightforwardly for practical purposes but measures very precisely, and can be immersed in the test medium, is characterized in that on its cylindrically configured outer surface, the stator has a circumferential groove or indentation in which the rotor adapted to the cross-sectional shape of the indentation on its inner surface in order to form the measurement gap can be or is hydrodynamically mounted at a distance from the surface of the indentation. In this case, it is advantageous that the surface of a stator part lies opposite a surface, facing away from the stator, of the rotor mounted in the indentation, at a distance and while forming a further measurement gap of a hydrodynamic bearing.

In this way, a double-gap system is obtained, which represents a combination of the Couette and Searle principles and ensures outstanding hydrodynamic bearing.

In order to be able to replicate the “ball/plate geometry” which is advantageous for measurements of rheological parameters in rotary rheometers according to the invention, according to the invention provision may be made that the following relationship applies for the gap width of the respective measurement gap at the distance from the rotation axis

R1/R2=S1/S2,

where R1 and R2 are the distances of points on the surfaces delimiting the measurement gap from the rotation axis of the rotor, and S1 and S2 are the gap thickness formed at these points R1 and R2 in the hydrodynamic bearing of the rotor, and this thickness of the respective measurement gap increases with an increasing distance from the rotation axis.

In principle, rotors having rotationally non-symmetrical outer surfaces may also be used, so long as they allow hydrodynamic bearing. Such rotors may have the cross section of polygons or ellipses.

The invention will be explained in more detail below by way of example with the aid of the drawings.

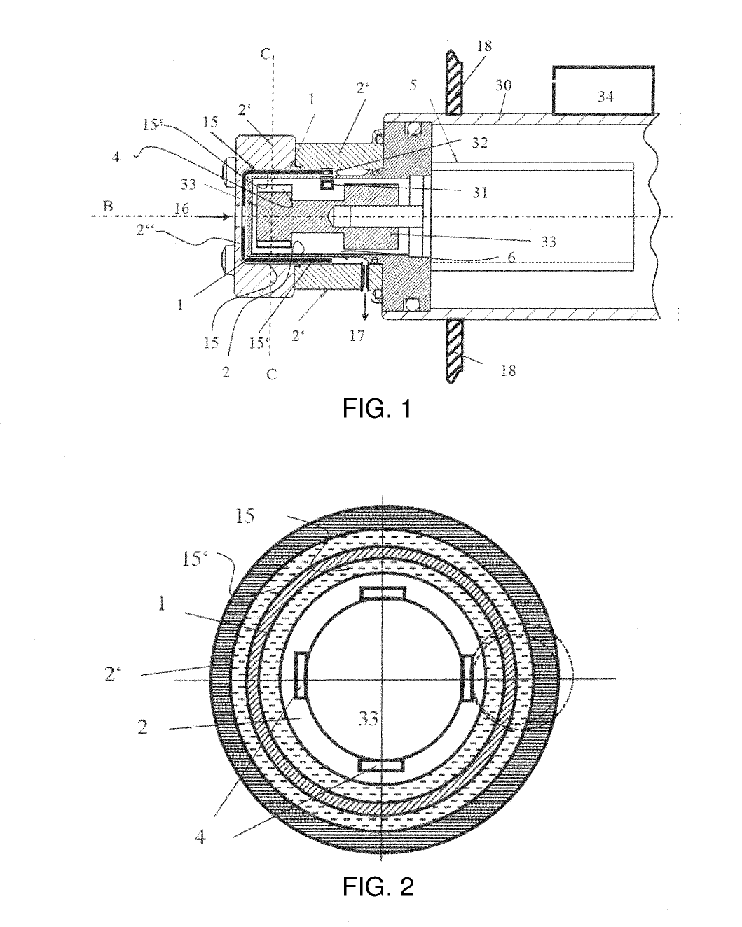

FIGS. 1 and 2 show a schematic longitudinal and cross section through one embodiment of a rotary rheometer according to the invention.

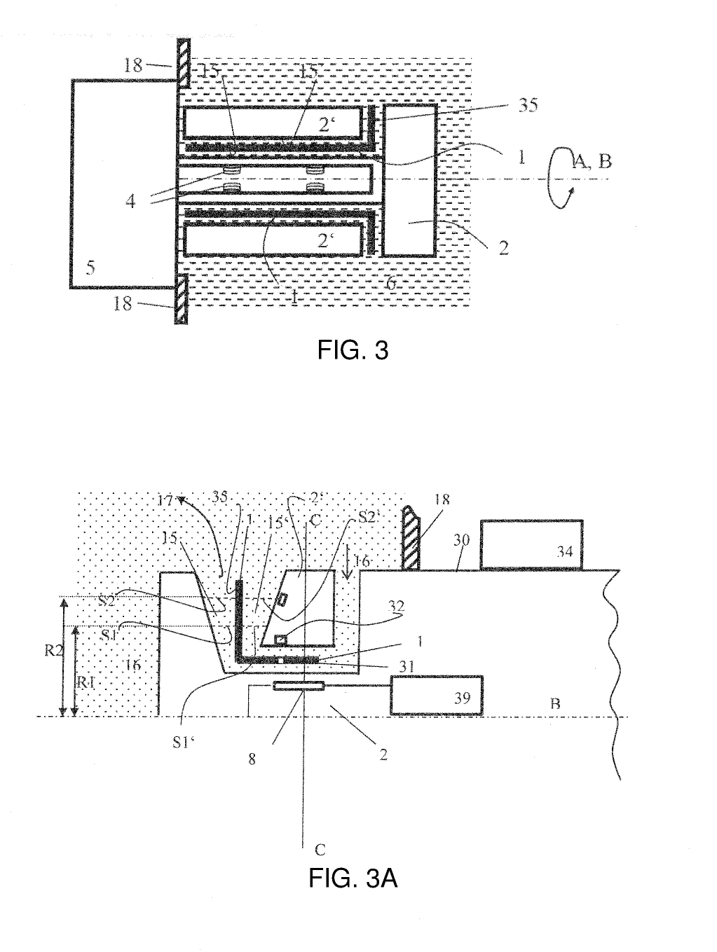

FIGS. 3 to 7 show schematic sections through further embodiments of rotary rheometers according to the invention.

FIG. 8 schematically shows the principle of a ball/plate rotary rheometer.

A rotary rheometer according to the invention very generally has a stationary, preferably rotationally symmetrical, outer or inner body functioning as a stator 2, which may also be formed as a closed container, a measurement body, preferably configured rotationally symmetrically, being arranged as a rotor 1 in this container and lying concentrically to the outer and/or inner stator 2. Between the rotor 1 and the stator 2 there is the measurement gap 15, and during rotation of the rotor 1 a hydrodynamic bearing is formed in the measurement gap 15 between the stator 2 and the rotor 1. Deviations from the concentric position due to the weight of the rotor 2 may in principle occur in the rheometers according to the invention, but they play no part in the measurement, including in particular in the case of positioning the stator axis B in a manner differing from the vertical, and may be neglected.

In principle, the hydrodynamic bearing, provided according to the invention, of the rotor 1 is carried out especially in the radial direction with respect to its rotation axis A. The bearing in the axial direction may take place either likewise by hydrodynamic bearing on the end surfaces of the rotor 1 or by arranging small guide magnets on the rotor 1 and soft iron parts 10 on the stator 2, which magnets 9 and soft iron parts 10 respectively face one another and restrict the possibility of movement of the rotor 1 in the direction of the rotor axis A. Very generally, contactless driving of the rotor 1 is possible with the eddy current drive, without having to use mechanical or magnetic bearings.

Very generally, which test media 6 bring the rotor 1 into a stable position with respect to the stator 2 when starting up or running up, and then maintain the mutual position of the rotor 1 and the stator 2 and laminar layering of the test medium 6 in the measurement gap 15 in the stationary measurement operation because of their special density parameters, viscosity parameters and rheological parameters, is dependent on the design configuration, in particular the radius of the magnetic rotor 1, the width or thickness of the measurement gap 15, the profile of the mutual distance of the surfaces delimiting the measurement gap 15 and the rotational speed. In particular, the viscosity of the test medium 6 is in this case to be taken into account for the stability.

The hydrodynamic bearing should be configured, or dimensioned, in such a way that the rotor 1 is held inside the stator 2 in an ideal central position, or approximately in the central position, such as can be predetermined by a hydrodynamic bearing. The rotor 1 should furthermore be driven in such a way that, in the case of a rotor axis A inclined with respect to the horizontal, it sufficiently floats and no vortices are formed in the test medium 6. When the rotor 1 rotates around the stator 2, the rotor 1 is held by the hydrostatic bearing at an approximately constant distance around the stator 1.

The hydrodynamic bearing is commensurately better when the density of the rotor 1 and the density of the test fluid to be measured are more similar, in particular when the rotor 1 having a cylindrical circumferential surface and at most end surfaces inclined thereto is rotated in an adapted interior, having a cylindrical inner wall surface and at most end surfaces inclined thereto, of a stator 2 by the eddy current drive. In order to compensate for different densities of the rotor 1 and of the test medium 6, the rotor rotational speeds may be increased, or adapted.

For the determination of the measurement values, or the rotational speeds, sensors 31, 32, for example Hall sensors, optical sensors, capacitive, inductive sensors and other contactlessly operating measurement devices, with which the rotational speed of a rotor 1 can be measured, may be used in all embodiments. Eddy current sensors may also be envisioned.

In principle, it is also possible to drive the eddy current body 3, or the permanent magnets 4 to be rotated, mechanically, for example via a belt drive by a drive motor; it is necessary to determine the precise rotational speed of the magnets.

Since the viscosity of a fluid is in the general case temperature-dependent, a temperature measurement may also be provided. This is done with a sensor 14 (thermocouple, etc.) which is mounted flush on the gap pot, or stator 2, as close as possible to the test medium 6, or directly on the stator surface in contact with the test medium 6, without interfering with the flow, or may be arranged on or in the rotor 1. The sensor then comprises means for contactless transmission of the measurement values to the stator 2, or to the stationary parts of the measuring instrument.

Particularly advantageous and generally usable is the embodiment of the eddy current drive 3 with a magnetic return path, the effect of which is that the field lines can be guided in a more defined way perpendicularly to the surfaces of the rotor 1. For this return path, soft iron or another soft magnetic material, with which stator parts 2″ and further stator parts 2′ are formed, is used, which parts may also be provided for the formation of an increased or longer or further measurement gaps 15. With such stator parts 2′, 2″, a measurement gap 15, 15′ can be formed on the inner wall surface and on the outer wall surface of the rotor 1.

Very generally, in the rotary rheometers according to the invention, in order to form eddy currents either rotating permanent magnets 4 or coils 8 that generate a rotating magnetic field are used. This is done according to the design configuration and the intended purpose.

FIG. 1 shows the basic structure of one embodiment of a rheometer according to the invention in section. A housing 30 carries a stator 2 which is configured rotationally symmetrically with respect to a stator axis B and which extends in the shape of a pot, or as a cylinder, from the housing 30. Placed on the stator 2, there is a pot-shaped rotor 1 configured rotationally symmetrically with respect to the rotor axis A, which encloses the stator 2 while forming a distance. The rotor 1 is enclosed, while forming a distance, by further stator parts 2′, 2″ which are connected to the housing 30. In this way, a measurement gap 15 and 15′ with a hydrodynamic bearing for the rotor 1 is respectively formed between the inner and outer cylinder surfaces of the rotor 1 as well as the inner and outer end surfaces of the rotor 1 and the outer surface of the stator 2 and the inner surface of the stator parts 2′, 2″. Permanent magnets 4 are arranged distributed around the rotor axis A inside the stator 2 on a carrier 33, the carrier 33 being rotatable about the stator axis B by a drive 5. Test medium 6 can enter the two measurement gaps 15, 15′ through an opening 16. The test medium 6, driven by the rotation of the rotor 1, can leave the measurement gaps 15, 15′ again through an outlet opening 17.

Devices 31, 32 are provided for measuring the rotational speed of the permanent magnets 4, for example Hall probes, the interacting measurement parts of which are arranged on the one hand on the carrier 33 of the permanent magnets 4 and on the other hand on the housing 30. In a similar way, measurement units of an inductive, optical or capacitive type may be provided in order to determine the rotational speed of the rotor 1. These measurement units are carried by the rotor 1 and by the stator 2, or the stator parts 2′, 2″, or the housing 30. The rotor 1 is rotated by the rotation of the permanent magnets 4, which induce in the rotor 1 consisting of soft iron eddy currents which in turn cause the rotor 1 to rotate because of the electromagnetic forces occurring. In this case, as in all other embodiments of the invention, the permanent magnets 4 are configured rotationally symmetrically and axially symmetrically with respect to the stator axis B and the rotation axis A of the rotor 1. The rotor 1 rotates because of the rotating magnetic field, which in the present case is generated by the permanent magnets 4, the drive rotational speed of the rotor 1 being predetermined by the rotational speed of the permanent magnets 4, or the rotational speed of the drive motor 5.

The rotational speed of the permanent magnets 4 may be determined in the same way as the rotational speed of the rotor 1, with contactlessly measuring measurement units 31 and 32, for example Hall sensors, inductive, optical or capacitive measurement units. As an alternative, the rotational speed specification of the motor may be used for the further calculation.

The rotor 1 is held in the axial position on the stator axis B by the further stator parts 2′, 2″, which engage around the end wall of the rotor 1. A hydrodynamic bearing is therefore also formed on both sides on the end wall 1′ of the rotor 1.

By means of the hydrodynamic bearing along the rotor 1, the rotor 1 is centered with respect to the stator axis B in the radial direction, and positional stabilization in the direction of the stator axis B is carried out by the further stator parts 2″.

In order to be able to measure different test media 6, very generally the geometry of the arrangement, or the dimensions of the rotor 1 and optionally of the stator 2 and of the further stator parts 2′, 2″, in particular the gap thickness of the measurement gap 15, 15′, may be varied so that a hydrodynamic bearing can always be achieved for the measurement. In this way, any bearing friction or bearing forces, which are caused by mechanical bearing or by a magnetic bearing, are excluded. It is merely necessary to overcome the liquid friction, which is however a measurement parameter of interest and can be used as a measure of the properties of the test medium. FIG. 2 shows a section along the line C-C in FIG. 1. The carrier 33 for the permanent magnets 4, arranged with alternate poling along the circumference of the carrier 33 inside the stator 2, can be seen. Directly around the stator 2 there is the first measurement gap 15, which is outwardly bounded by the rotor 1. The rotor 1 is outwardly enclosed by the further measurement gap 15′, which is outwardly bounded by the further stator parts 2′.

Very generally, the rotary rheometers according to the invention may be used in any desired position or inclination, since because of the hydrodynamic bearing formed on both sides of the rotor 1 the spatial orientation of the rotor axis A plays no role and the rotor 1 is always supported while forming measurement gaps 15, 15′, which allow hydrodynamic bearing, between the stator 2 or the stator parts 2′ or the further stator parts 2″. Unequal weight distributions which may occur can be compensated for by the hydrodynamic bearing.

FIG. 3 shows an arrangement in which permanent magnets 4, which are arranged following one another with alternate poling, are rotated inside the elongate cylindrical stator 2 by the drive 5. The rotor 1 has in this case the configuration of a hollow cylinder with an outwardly protruding collar 35. The inner measurement gap 15 is bounded by the outer surface of the stator 2 and by the inner surface of the rotor 1. The further measurement gap 15′ is bounded by the outer surface of the rotor 1 and by the inner surface of the stator part 2′. With a further stator part 2″, the rotor 1 is held in an essentially fixed position during its rotation by means of the collar 35 in the longitudinal direction of the stator axis B. The collar 35 is mounted while forming a hydrodynamic bearing between the stator parts 2′ and the further stator part 2″, and the measurement gaps 15″ placed on both sides of it improve the measurement accuracy.

Very generally, the rotation axis of the permanent magnets 4 and the stator axis B extend coaxially. In the ideal case, the rotation axis A of the rotor 1 coincides with these axes. This is the case, in particular, when the stator axis B is oriented vertically during measurement operation. If the stator axis B is arranged horizontally or at an angle with respect to the horizontal, small differences between the profiles of the rotor axis A and of the stator axis B may occur because of the rotor weight.

FIG. 3a shows a similar alternative arrangement. In this case, the conductive rotor 1 is driven by a revolving magnetic field generated by coils 8. Electromagnetic coils 8 are arranged inside the stator 2, and specifically are distributed around the stator axis B. With a supply unit 39, a magnetic field revolving around the stator axis 2, with which the rotor 1 mounted rotatably around the stator 2 is driven, is created by the coils 8. In order to achieve a constant shear rate over the entire measurement gap, the measurement gaps 15, 15′ and 15″ are configured in such a way that for any desired distance R1 and R2 from the rotation axis A of the rotor (or from the rotation axis B of the stator), the following applies for the associated gap widths S1 and S2:

R1/S1=R2/S2=R1/S1′=R2/S2 and respectively R1/R2=S1/S2=S1′/S2′

The fluid 6 to be studied is moved through the measurement gaps 15, 15′ by the rotor 1, which is represented in FIG. 3a by the inlet openings 16 and the outlet opening 17.

In this case, the two gaps 15, 15′ extend around the cylindrical surfaces of the rotor 1 with a constant gap width s (R=constant), while the gap widths around the projecting rotor part 35 widen with an increasing distance S from the rotation axis.

FIG. 5 shows a cylindrical rotor 1 which is fully enclosed by the stator 2. The stator 2 is a container closed on all sides and is filled with test fluid 6. Between the outer wall surface of the rotor 1 and the cylindrical inner wall surface of the stator 2, the measurement gap 15, which is simultaneously used as a hydrodynamic bearing, is formed.

Permanent magnets 4 are carried by a carrier 43 which can be rotated around the stator 2 by a drive 5. These rotating permanent magnets 4 cause the rotation of the rotor 1 inside the stator 2. The rotor 1 used as an eddy current body is made of electrically conductive material which is nonmagnetizable and nonmagnetic. The stator 2 is advantageously made of nonmagnetizable and nonmagnetic material. Measurement units 31, 32 are provided for measuring the rotational speed of the rotor 1. Likewise, the rotational speed of the rotating permanent magnets 4 is detected by a measurement unit 40. These measurement values are evaluated with an evaluation unit 34.

Instead of the rotating permanent magnets 4, it is possible to use a rotating magnetic field created by coils.

In order to improve the hydrodynamic bearing in the axial direction, the end surfaces of the cylinder are additionally chamfered in the axial direction. In the embodiment represented, the inner wall of the stator 2 matches the end surfaces of the rotor and extends approximately parallel to them. In order to achieve defined shear rates, the gap section 15a at the end surfaces may be configured in such a way that the condition R1/R1=S1/S2 is again satisfied.

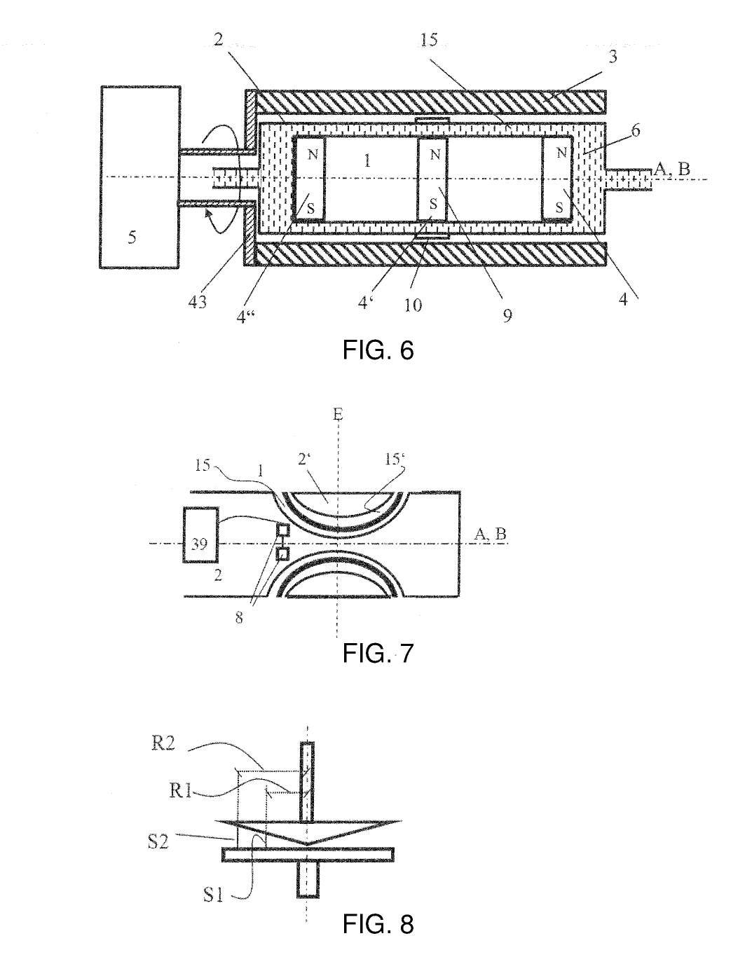

FIG. 6 shows an embodiment which is almost identical in terms of structure to the structure represented in FIG. 5. In this case, however, the at least one permanent magnet 4 is arranged inside the rotor 1 and a cage or a pot-shaped conductor loop is rotated with the carrier 43, driven by the drive 5, as an eddy current body 3, so that the rotor 1 is set in rotation about its rotation axis A. As represented by way of example in the drawing with the magnets 4′, 4″, a plurality of permanent magnets may also be arranged as symmetrically as possible, so that the rotor has a uniform mass distribution along its axis and the magnetic forces are symmetrical, in order to prevent tumbling of the rotor in the hydrodynamic bearing. The entirely cylindrical rotor is stabilized in its position with respect to the axis in the longitudinal direction of the stator axis B by soft iron parts 10 arranged on the stator 2, which lie opposite at least one of the rotating magnets of the rotor.

Very generally, predominantly cylindrical rotors with insufficient axial hydrodynamic bearing in the longitudinal direction of the rotor axis A or the stator axis B can be stabilized by magnets 9 arranged suitably on the rotor 1 and/or on the stator 2 and soft iron parts 10 lying opposite these.

The permanent magnets 4 or the eddy current body 3 according to FIGS. 5 and 6 rotate externally around the stator 2, in which the rotor 1 floats freely. The hydrodynamic bearing is in this case commensurately better when the specific density of the rotor 1 and the density of the test medium 6 to be measured are more similar. The rotational speeds will be selected to be commensurately higher when the density of the rotor and of the liquid to be measured are more different. In particular, rotational speed ranges of from 0.2 to 2000 rpm and even up to 10 000 or 30 000 rpm may be envisioned, since the rotor 1 has to float in the central position, when the rheometer is operated with a horizontally oriented stator axis B. In general, a high torque, or a high rotational speed, is necessary for the rotor 1, which also depends on the size of the stator 2 or the interior of the stator 2, which encloses the rotor 1, and the dimensions of the rotor 1 as well as the parameters of the test medium 6.

FIG. 7 shows a rotary rheometer in which electromagnetic coils 8 are arranged inside the stator 2, and specifically are distributed around the stator axis B. With a supply unit 39, a magnetic field revolving around the stator axis 2, with which the rotor 1 mounted rotatably around the stator 2 is driven, is created by the coils 8. The stator 2 has on its cylindrically configured outer surface a circumferential groove or indentation 20 in which rotor 1, adapted to the cross-sectional shape of the indentation 20 on its inner surface in order to form the special geometry of the measurement gap 15, can be or is hydrodynamically mounted at a distance from the surface of the indentation 20.

By the stator parts 2′, the rotor 1 is positionally stabilized on the stator 2 in the direction of the stator axis B, or the magnetic return path is reinforced. Between the surface, facing toward the stator 2, of the rotor 1 and the outer surface of the stator 2 lies the measurement gap 15, which is extended centrally symmetrically with respect to the stator axis B and the rotor axis A and is configured symmetrically with respect to a plane E which passes perpendicularly to the rotation axis A, or to the stator axis B, through the middle of the measurement gap 15.

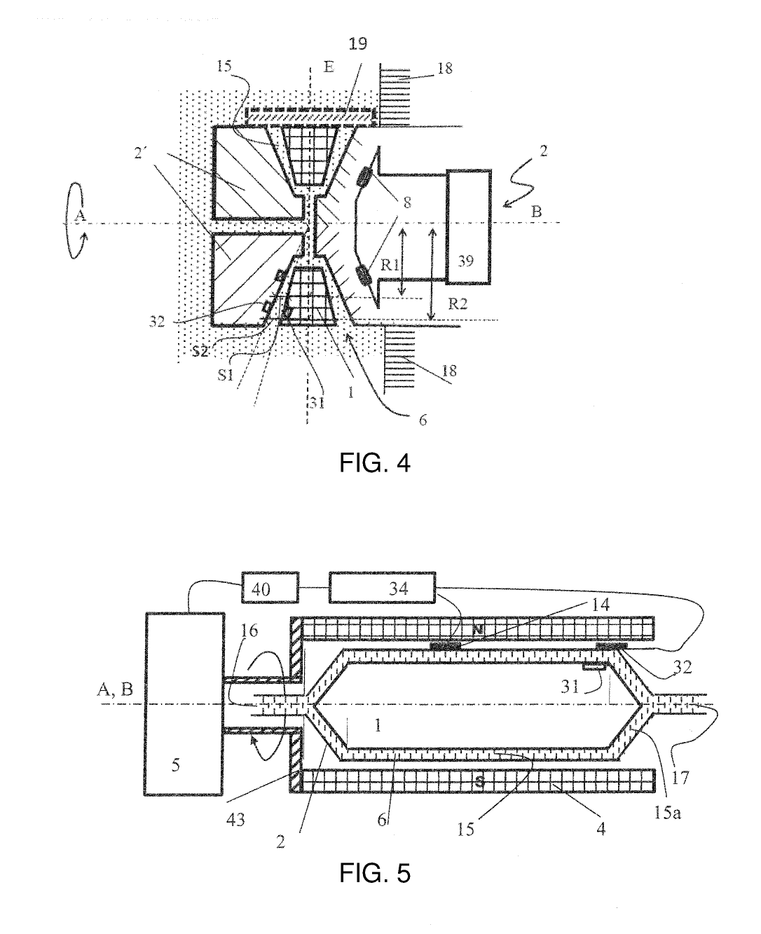

Very generally, it may be stated that, in a section extending through the rotation axis A of the rotor 1, or through the stator axis B, the measurement gap 15, or the surfaces of the rotor 1 and the stator 2 delimiting the measurement gap 15, have at least one straight, kinked, bent and/or curved section which extends in an inclined fashion with respect to the rotation axis A, or with respect to the stator axis B, or makes therewith an acute angle whose vertex is directed into the interior of the measurement gap 15 and/or that mutually opposing surfaces of the measurement gap 15 are respectively configured centrally symmetrically with respect to the rotation axis A, and/or that the surfaces delimiting the measurement gap 15 respectively extend symmetrically with respect to a mid-plane E, extending perpendicularly to the rotation axis A, of the measurement gap 15. Such a structure of a measurement gap can be seen, in particular, in FIGS. 4 and 7.

In the present case, the surface of the indentation 20 in the stator 2, and the surfaces of the rotor 1 as well as the inner surface of the advantageously provided further stator part 2″ are curved. The measurement gaps 15, 15′ vary in their distance; the inner-lying measurement gap 15 becomes larger from the inside outward; the thickness of the outer-lying measurement gap 15′ decreases outward. The thickness of the measurement gap 15 varies accordingly. This thickness change is selected in such a way that it does not interfere with a hydrodynamic bearing being maintained.

The rotational speed of the rotor 1, which because of the test medium 6 present the two measurement gaps 15 and 15′ is less than the rotational speed of the magnetic field generated by the coils 8, is measured with measurement units 31, 32.

FIG. 7a schematically shows an embodiment in which the rotor 1 runs on a stator 2, the shape of which essentially corresponds to a part of a lateral surface of a cone. The axial and radial bearing of the rotor in this case take place on the same rotor surface, the components in the radial and axial directions correspond to the projections of the lateral surface onto the planes through the rotation axis and the normal thereto.

The embodiments of the rheometer according to FIGS. 4, 7 and 7a can be fitted particularly straightforwardly into the wall 18 of a tube or a container, and the test medium 6 contained in the tube or container can be measured.

For rotary rheometers having a ball/plate measurement system, it is known that constant shear rates over the entire gap are achieved when—as represented in section in FIG. 8—the following applies for the gap height s at an arbitrary distance or radius r from the rotation axis: R1/R2=S1/S2. This means that the gap heights increases constantly with an increase in the distance R from the rotation axis A of the rotor 11. This condition may also be implemented in rotary rheometers according to the invention, particularly in rheometers according to FIGS. 1a, 4 and 7.

FIG. 4 represents a rotary rheometer in which the rotor 1 has a frustoconical shape and delimits in a measurement gap 15 and which, according to the condition above, has a measurement gap 15 tapering toward the rotation axis A and toward the gap mid-plane E and satisfying this condition. With appropriate reconfiguration of the rotor 1, of the indentation 20 and of the stator part 2′, the rotary rheometer represented in FIG. 7 could also satisfy this condition for measurement gaps 15, 15′. In the embodiment represented, only the inner-lying measurement gap satisfies this condition. This condition could apply for the gap geometry used in FIG. 7 when the two measurement gaps 15 and 15′, which lie between the inner surface of the rotor 1 and the stationary outer surface of the stator 2 and between the outer surface of the rotor 1 and the inner surface of the stator part 2′, open increasingly wider radially, or outward, and satisfy the condition above. In this case, constant shear rates can be exerted on the fluid to be studied. Therefore, particularly in the case of carrying out calibration, non-Newtonian liquids may also be studied straightforwardly.

Very generally, it is advantageous for all mutually opposing surfaces delimiting measurement gaps 15 or 15′ to be configured rotationally symmetrically or centrally symmetrically, or to be concentric. This also applies for the eddy current body 3 and the stator parts 2′ and 2″. Furthermore, the components used are advantageously constructed homogeneously.

For the invention, it is unimportant whether the rotor 1 rotates inside a stator 2 or around the stator 2, since a hydrodynamic bearing is always formed between the rotor 1 and the stator 2.

For the person skilled in the art, it is readily possible to adapt to one another the thickness and geometry of the measurement gaps 15 or 15′ formed as well as the dimensions of the rotor 1 and of the stator 2, so that a hydrodynamic bearing for testing a particular test medium 6 can always be achieved. In particular, by replacing rotors 1 and selecting other thicknesses, lengths or specific weights of the rotors 1, adaptation to test media 6 having different densities and/or rheological properties can be carried out easily. Adaptation is also straightforward to achieve by selection of the drive rotational speeds which are predetermined by revolving magnetic fields or revolving permanent magnets 4 or revolving eddy current bodies 3.

The permanent magnets 4 or coils 8 provided are arranged centrally symmetrically with respect to the rotor axis A. At least two, and preferably more than two, permanent magnets 4 or coils 8 are provided. Permanent magnets following one another along the circumference are arranged with opposite poling; the coils 8 may have their polarities reversed correspondingly.

In principle, the rotational speed of the rotating magnetic field and the drive rotational speed are dictated by the rotation of the permanent magnets 4 or the rotational speed of the revolving magnetic field or of the revolving eddy current body. These rotational speeds can be measured precisely. In order to determine the desired rheological parameters, the rotor rotational speed which is achieved because of the braking of the rotor by the test medium is measured. It is possible to carry out calibration of a rotor or a rheometer with fluids of known viscosity or known parameters and to compile a calibration table which relates rotational speeds of the rotor obtained at particular temperatures or pressures to actual viscosity values or rheological parameters.

Very generally, and for example for FIGS. 1, 3 and 7, it is true that the hydrodynamic bearings or measurement gaps 15, 15′, 15″ formed may have radially and axially extending bearing sections or measurement gap sections 15, 15′, 15″. The hydrodynamic bearing sections extending in the radial direction establish the position of the rotor in the longitudinal direction of the stator axis B. The bearing sections which extend in the axial direction, or in the longitudinal direction of the rotor axis A, establish the radial orientation of the rotor 1. In the case of a rotary rheometer as represented by way of example in FIG. 7, the measurement gaps 15, 15′ cannot be separated into axial and radial bearing sections. Because of the curvature of the measurement gaps, at each point there is a radial and axial component, and a hydrodynamic bearing is therefore ensured overall in both the axial and radial directions. Spherical, or elliptically or ovoidally configured bearing geometries may therefore also be envisioned. What is important in this case is that the projected surface in the axial and radial directions is sufficient for a hydrodynamic bearing.

Non-Newtonian fluids exhibit a dependency on the shear rate in their parameters, in particular viscosities. In order to be able to assess real non-Newtonian fluids, a constant shear rate over the actual measurement gap would need to be applied to the fluid to be measured. In order to achieve this, the measurement gap must be specially configured. The shear rate is intended in this case to mean the increase in the velocity in the gap.

The ends of the rotors 1 used in the rotary rheometers according to the invention may end in a rounded fashion or tapering to a point in the manner of a torpedo. In these regions, the opposing surfaces on the stator 2 or the stator parts 2′ or 2″ may have a corresponding inclination or adaptation.

The diameter of the rotors 1 is selectable; for example, aluminum or copper rotors 1 with a diameter of 0.5 cm and a length of from 3 to 4 cm or with a diameter of 1 cm and a length of from 15 to 20 cm may be selected; the gaps formed in this case have gap widths of a few tenths of a millimeter, for example 0.2 mm or 0.5 to 1 mm, and rotational speed values of for example 500 rpm in a rotational speed range of from less than 1 rpm up to 10 000 rpm may be used. It is however, also readily possible to use rotors 1 which have a diameter of 20 cm. It is, however, advantageous for the length of the rotor to be greater than the diameter approximately by a factor of from 3 to 6, in particular 4 to 5, since in this way edge effects occur to a minimized extent and may remain neglected. The in principle arbitrarily long configuration of the rotor has an upper limitation based on handleability, manufacturing conditions and cleaning.

It is advantageous for a temperature which is constant as a function of time and position to prevail in the test medium during the measurement. Temperature regulation may therefore be carried out with preferably rotationally symmetrical Peltier elements or with a jacket thermally regulated by liquid and/or with heating resistors.

1-23. (canceled)

24. A rotary rheometer, comprising:
a rotationally invariantly disposed stator having a stator axis;
an eddy current drive;
a rotationally symmetrically configured rotor which can be rotated by means of said eddy current drive about the stator axis of said stator around or inside said stator and is placed with its rotation axis coaxial to the stator axis;
at least one measurement gap formed between mutually opposing surfaces of said rotor and said stator, a test medium to be studied being introducible via said at least one measurement gap;
a measurement unit with which a rotational speed of said rotor lying in contact with the test medium can be established;
an evaluation unit with which a rotational speed difference between the rotational speed applied to said rotor by said eddy current drive and the rotational speed of said rotor measured during a measurement process can be determined and used as a measurement value for rheological and/or viscous properties of the test medium; and
said measurement gap filled with the test medium to be studied functions, or is configured, as a hydrodynamic bearing between said rotor and said stator, and exclusively by a hydrodynamic bearing effect achieved by the rotation of said rotor relative to said stator, a distance and a mutual position of surfaces, facing toward one another and delimiting said measurement gap, of said rotor and said stator are specified and adjusted and are maintained during the measurement process.

25. The rotary rheometer according to claim 24, wherein end regions of said measurement gap communicate freely, without a cross-sectional narrowing of an end region of said measurement gap, and with outer regions following on from said end regions, or the test medium lying in said regions, or said end regions merge directly into said outer regions.

26. The rotary rheometer according to claim 24, wherein said rotor, apart from said hydrodynamic bearing in a region of said measurement gap, is supported without contact and without a bearing, and without magnetic bearings, on or opposite said stator in a radial direction relative to said rotation axis.

27. The rotary rheometer according to claim 24, wherein:
in order to form said eddy current drive, which sets said rotor in rotation, said rotor is formed from a nonmagnetic, nonmagnetizable, electrically conductive material; and
said eddy current drive has permanent magnets which can be rotated about the stator axis and are mounted around said rotor or at least partially inside said rotor or electromagnetic coils, with which a magnetic field that can be rotated about the stator axis can be generated, are mounted around said rotor or at least partially inside said rotor.

28. The rotary rheometer according to claim 24, wherein:
in order to form said eddy current drive, which sets said rotor in rotation, said rotor is formed from a nonmagnetic, nonmagnetizable, electrically conductive material; and
said eddy current drive has permanent magnets or coils mounted at least partially inside said stator, said permanent magnets being rotatable about the stator axis and a magnetic field that rotates about the stator axis being generatable with said coils.

29. The rotary rheometer according to claim 24, wherein said eddy current drive which sets said rotor in rotation, has:
permanent magnets disposed positionally fixed inside said rotor, or are connected to said rotor; and
an eddy current body formed entirely of a nonmagnetic, nonmagnetizable, electrically conductive material, as a cage, a pot or a conductor loop, which can be rotated around said rotor.

30. The rotary rheometer according to claim 24, wherein:
said rotor is disposed in an interior of said stator having a rotationally symmetrical inner wall and a shape of a rotationally symmetrical container or cup; and
said eddy current drive which sets said rotor in rotation, has permanent magnets being disposed positionally fixed inside said rotor, or being connected to said rotor, and a material of said rotationally symmetrical container or said cup, being a nonmagnetic, nonmagnetizable, electrically nonconductive material and an eddy current body formed of a nonmagnetic, nonmagnetizable, electrically conductive material, namely a pot, a cage or a conductor loop, being provided, which can be rotated around said stator.

31. The rotary rheometer according to claim 24, wherein in a section extending through the rotation axis of said rotor, or through the stator axis, said measurement gap, or said surfaces of said rotor and said stator delimiting said measurement gap, have at least one straight, kinked, bent and/or curved section which extends in an inclined fashion with respect to the rotation axis, or with respect to the stator axis, or makes therewith an acute angle whose vertex is directed into an interior of said measurement gap and/or in that said mutually opposing surfaces of said measurement gap are respectively configured centrally symmetrically with respect to the rotation axis, and/or in that said surfaces delimiting said measurement gap respectively extend symmetrically with respect to a mid-plane, extending perpendicularly to the rotation axis, of said measurement gap.

32. The rotary rheometer according to claim 24, wherein said rotor is configured cylindrically, annularly, in a shape of a pot, in a shape of a cone or frustoconically or, in section in a plane extending through the rotation axis, triangularly, trapezoidally or as a segment of a conic section or of an ovoid.

33. The rotary rheometer according to claim 24, wherein a surface of said stator or of one stator part or of a further stator part respectively lies opposite said rotor on at least one of said rotor surfaces, and during a rotation of said rotor, said rotor is supported without contact in a radial and also in an axial direction with respect to the stator axis by the hydrodynamic bearing effect of the test fluid prevailing in said measurement gap between said surfaces.

34. The rotary rheometer according to claim 24, wherein:
said stator is configured in a shape of a closed pot or cylinder;
said rotor has a shape of an open pot and is fitted via its interior on said stator while forming said measurement gap; and
said stator having at least one stator part and/or a further stator part being placed on a side of said rotor facing away from said stator at a distance from said rotor, namely opposite its end wall and/or circumferential wall, and a distance between said rotor and said stator part or said further stator part being configured as said measurement gap causing said hyrodynamic bearing.

35. The rotary rheometer according to claim 34, said stator has a cylindrically configured outer surface with a circumferential groove or indentation formed therein and in which said rotor adapted to a cross-sectional shape of said indentation on its inner surface in order to form said measurement gap can be or is hydrodynamically mounted at a distance from a surface of said indentation.

36. The rotary rheometer according to claim 35, wherein a surface of said stator part lies opposite a surface, facing away from said stator, of said rotor mounted in said indentation, at a distance and while forming a further measurement gap of the hydrodynamic bearing.

37. The rotary rheometer according to claim 24, wherein the following relationship applies for a gap width of said measurement gap at a distance from the rotation axis
R1/R2=S1/S2,
where R1 and R2 are distances of points on surfaces delimiting said measurement gap from the rotation axis of said rotor, and S1 and S2 are gap thicknesses formed at the points R1 and R2 in said hydrodynamic bearing of said rotor, and a thickness of said measurement gap increases with an increasing distance from the rotation axis.

38. The rotary rheometer according to claim 24,
further comprising a drive unit; and
wherein a geometry, namely a distance and a distance profile of mutually opposing surface sections of said measurement gap, namely a radial distance of mutually opposing surfaces, enclosing the rotation axis, of said rotor and said stator, are selected in order to form the hydrodynamic bearing as a function of rotational speeds applied by said drive unit, a previously estimated value of the viscosity and/or previously estimated rheological parameters of the test medium.

39. The rotary rheometer according to claim 24, wherein said rotor has a cylindrical circumferential surface and at most end surfaces inclined thereto is provided, which is fully enclosed on all sides by an interior, having a cylindrical inner wall surface and at most end surfaces inclined thereto, of said stator and inside said interior by the test medium, an eddy current body, which has a shape of a pot, a cage or a conductor loop and is formed from nonmagnetic or nonmagnetizable, electrically conductive material, being mounted rotatably around said stator, permanent magnets being mounted in said rotor or connected thereto.

40. The rotary rheometer according to claim 39, wherein said stator has a closable introduction opening formed therein for the test medium.

41. The rotary rheometer according to claim 24, further comprising mutually opposing interacting permanent magnets and soft iron parts, in order to stabilize a position of said rotor with respect to said stator in a longitudinal direction of the stator axis, said mutually opposing interacting permanent magnets and said soft iron parts, which contactlessly stabilize the longitudinal position of said rotor relative to the stator axis, are disposed on said rotor and on said stator.

42. The rotary rheometer according to claim 24, wherein a flow which is sufficiently laminar and vortex-free for a formation of the hydrodynamic bearing effect is formed in said measurement gap during rotation of said rotor.

43. The rotary rheometer according to claim 29, wherein at least one of said rotor, said stator or said eddy current body rotated around said rotor have a high electrical conductivity and are made of Cu, Pt, Ag or Au.

44. The rotary rheometer according to claim 24, further comprising heating and/or cooling units for the test medium disposed in said stator.

45. The rotary rheometer according to claim 24, wherein said measuring unit is one of a plurality of contactless measurement units for measuring at least one of the rotational speed of said rotor, a drive rotational speed which can be specified by said eddy current drive, a temperature, a pressure, or a density in said measurement gap are disposed on at least one of said stator, on said rotor or inside said measurement gap.

46. The rotary rheometer according to claim 29, wherein a rotation axis of said eddy current body, being a pot, a cage or a conductor loop, lies coaxially to the rotation axis of said rotor.
